(19) United States
(12) Patent Application Publication
(10) Pub. No.: US 2019/0061080 A1
(43) Pub. Date: Feb. 28, 2019

(54) System and Method for Slag and Fume Management for Thermal Processes

(71) Applicant: Hypertherm, Inc., Hanover, NH (US)

(72) Inventors: Justin Gullotta, Brownsville, VT (US); Clifford G. Darrow, Lyme, NH (US); Martin Higgens, Lebanon, NH (US); Jon Lindsay, Grantham, NH (US); Garrett Quillia, Enfield, NH (US)

(21) Appl. No.: 16/109,074

(22) Filed: Aug. 22, 2018

Related U.S. Application Data
(60) Provisional application No. 62/548,517, filed on Aug. 22, 2017.

(51) Int. Cl. B23Q 11/00; B01D 46/10; B08B 5/04; B08B 15/04; B23K 37/00

(52) U.S. Cl. CPC B23Q 11/0046; B01D 46/10; B23Q 11/0075; B08B 15/04; B23K 37/003; B08B 5/04

(57) ABSTRACT

A system to prevent a flow of gas and particulates from spreading to atmosphere during a material processing operation includes a slag deflector disposed proximate a torch during the material processing operation. The slag deflector includes a thermally-conductive base portion having an impact surface facing the torch. The impact surface is shaped to prevent the flow of gas and particulates from the material processing operation from spreading in a direction away from the torch, and to redirect the first flow of particulates to a surface configured to inhibit the first flow of particulates from flowing to atmosphere. The slag deflector includes a coolant flow channel configured to thermally-regulate the impact surface of the thermally conductive base portion.

### RELATED APPLICATIONS

This application claims the benefit of U.S. Provisional Patent Application Ser. No. 62/548,517, filed Aug. 22, 2017, entitled “Improved Method for Slag and Fume Management for Thermal Processes,” the contents of which are hereby incorporated herein by reference in their entirety.

### TECHNICAL FIELD

This disclosure relates generally to systems for management of slag and fume generated during material processing operations, and more specifically to controlling the flow of particulates and gases resulting from plasma cutting or gouging and to related systems and methods.

### BACKGROUND

Thermal processing operations, e.g., those involving welding, plasma cutting, and gouging often generate, e.g., fumes, gases, slag, debris, particulate matter, etc. that is dispelled into the environment. Those unwanted byproducts can be dangerous and/or harmful to materials and operators in the vicinity. Current solutions to manage or handle those toxic fumes and (solid and molten) particulates in the material processing field, particularly with thermally-driven processes (e.g., with plasma cutting and gouging), use separate ventilation systems that are expensive, cumbersome, non-integrated, and inflexible (e.g., a large hooded area or ventilation chamber in which operations must be performed). The current solutions fail to effectively mitigate dangerous and superheated particulate matter dispelled by the material processing operation, including by failing to differentiate between gaseous and particulate emissions. Some prior art systems also involve spraying a coolant directly onto a workpiece and using a vacuum system to vacuum up coolant, fumes and gases, and slag and particulates alike. Some prior art systems use a vacuum head that is located in such close proximity to the cutting operation and/or generate a negative pressure or vacuum with enough strength to impact, e.g., an arc from a torch used for cutting, which has detrimental effects on the quality and effectiveness of a cutting or gouging operation. The deficiencies in the prior art can result in, e.g., more complicated or expensive ventilation setups, and ventilation setups that are more prone to damage and failure. The current solutions cannot be employed in many environmentally-sensitive work areas where thermal cutting and gouging processes need to be performed. The shortcomings of the current solutions are apparent during full penetration welding processes, as well as during carbon arc gouging processes.

### SUMMARY

What is needed are systems and methods for eliminating, e.g., toxic fumes and airborne (solid and molten) particulates more safely and effectively than currently-available solutions are able. There are several systems and methods that can be employed to address the issues with the currently-available solutions. For example, some solutions can involve using a different apparatus or method to manage slag and/or particulate matter from an apparatus or method used to manage fumes or gaseous matter. The different solutions can be combined to increase the effectiveness of the slag and fume management system or method.

Systems and methods are provided for redirecting and/or removing slag and fumes generated during material processing operations. The slag and fume management systems include a slag deflector for redirecting slag or particulate matter generated and dispelled during a material processing operation. The slag and fume management systems can include a ventilation or suction system that can manage and remove fumes or gases generated and dispelled during a material processing operation. For example, the slag and fume management systems can apply a negative pressure to draw fumes and gases into a ventilation system without drawing large amounts of slag or particulate matter (or in some cases any slag or particulate matter) into the ventilation system.

In one aspect, the invention features a system to prevent a flow of gas and particulates from spreading to atmosphere during a material processing operation. The system includes a slag deflector disposed proximate the torch during the material processing operation. The slag deflector includes a thermally-conductive base portion that has an impact surface facing the torch. The impact surface is shaped to prevent the flow of gas and particulates generated by the material processing operation from spreading in a direction away from a torch used in the material processing operation. The flow of gas and particulates can include a first flow of gas and a first flow of particulates. The impact surface is also shaped to redirect the first flow of particulates to a surface configured to inhibit the first flow of particulates from flowing to atmosphere. The system includes a coolant flow channel operably coupled to, or integral to, the thermally-conductive base portion. The coolant flow channel is configured to thermally regulate the impact surface of the thermally conductive base portion. In some embodiments, the system can include a receptacle for retaining the first flow of particulates redirected by the slag deflector.

The coolant flow channel can also include a closed-loop cooling system. The closed-loop cooling system can operate with a gas and/or a liquid, e.g., water or a commercially-available coolant. The closed-loop cooling system can include a heat exchanger, a fluid pump, and/or a flow control valve. The closed-loop cooling system can include a chiller.

In some embodiments, the system includes a suction device disposed proximate the slag deflector. The suction device is configured to provide a negative pressure to draw the first flow of gas away from a workpiece being processed and to permit the first flow of particulate matter to impact the slag deflector without being drawn into the suction device. A ventilation system can be operably coupled to the suction device. The ventilation system can include a containment vessel configured to capture a second flow of particulates that enter the ventilation system, in addition to the first flow of gas.

In some embodiments, the system can include a bottom member disposed proximate a bottom surface of the slag deflector. The bottom member is configured to maintain contact with a workpiece during a material processing operation.

A vertical deflector can be disposed proximate a top surface of the thermally-conductive base portion. The vertical deflector can be shaped to separate the first flow of gases from the first flow of particulates.

In some embodiments, the system can include an air jet. The air jet can be configured to apply a positive air flow proximate the impact surface and can be configured to direct the first flow of gases to the suction system. The air jet can be configured to apply a positive air flow proximate the impact surface of the slag deflector and can be configured to direct the first flow of particulates along the impact surface. The air jet can enshroud a region proximate the slag deflector with a positive air flow to prevent the first flow of particulates and the first flow of gases from escaping to atmosphere.

In one aspect, the invention features a method for particulate and gas removal. The method includes preventing a flow of particulate and gas from a material processing operation from spreading in a direction away from a torch. The flow of particulate and gas includes a first flow of particulate and a first flow of gas. The method includes redirecting the first flow of particulate to a surface configured to inhibit the first flow of particulate from flowing to atmosphere with an impact surface of a slag deflector. The method includes thermally regulating the impact surface of the slag deflector with a coolant flow channel.

In some embodiments, the method includes providing a negative pressure to draw the first flow of gas away from a workpiece and permit the flow of particulate to impact the slag deflector without being drawn into a suction device disposed proximate the slag deflector. The method can include filtering the input to the suction device and capturing a second flow of particulate that enters the suction device with a containment vessel. Individual particulates within the second flow of particulate can be smaller than individual particulates within the first flow of particulate.

In some embodiments, the method includes stopping particulate expelled from the material processing operation from spreading off the surface of a workpiece with a flexible member disposed proximate a bottom surface of the slag deflector in contact with the workpiece. The method can include separating the first flow of gas from the first flow of particulate with a vertical deflector disposed proximate a top surface of the thermally-conductive base portion. In some embodiments, the method includes capturing the first flow of particulate redirected by the slag deflector with a receptacle.

The method can include providing coolant to the coolant flow channel through a closed-loop cooling system. The method can include regulating the temperature of coolant in the closed-loop cooling system with a heat exchanger. The method can include regulating the temperature of coolant in the closed-loop cooling system with a chiller.

In some embodiments, the method includes enshrouding a region proximate the slag deflector with a positive air flow to prevent the first flow of particulate and the first flow of gas from escaping to atmosphere.

### BRIEF DESCRIPTION OF THE DRAWINGS

The advantages of the invention described above, together with further advantages, may be better understood by referring to the following description, taken in conjunction with the accompanying drawings. The drawings are not necessarily to scale, emphasis instead generally being placed upon illustrating the principles of the invention.

FIG. 1 is an exemplary prior art system for slag and fume management.

FIG. 2 is a block diagram of an embodiment of the invention, depicting a system for slag and fume management during material processing operations.

FIGS. 3A-E are different slag deflector embodiments for use with an exemplary system for slag and fume management during material processing operations.

FIG. 4 is an exemplary flow chart illustrating a method for slag and fume management during material processing operations.

### DETAILED DESCRIPTION

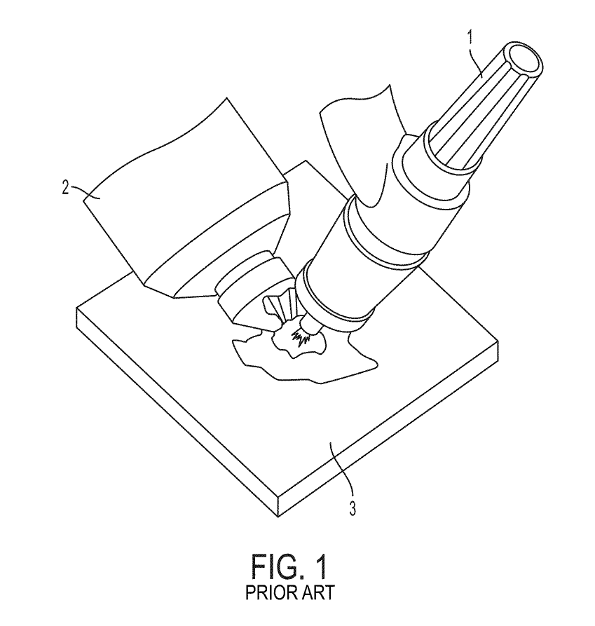

FIG. 1 is an exemplary prior art system for slag and fume management. Prior art systems for slag and fume management in material processing operations include torch 1, vacuum head 2, which is located at a very close proximity to the torch, and workpiece 3. Torch 1 performs a cutting or gouging operation on workpiece 3. Some prior art systems also include a vacuum hood (not shown) and/or a source of water or coolant (not shown) that is applied directly to or closely adjacent to the workpiece to cool gases and particulate matter. Vacuum head 2 of the prior art system then applies a vacuum to influence and shape the arc and remove each and all of the particulate matter, gases, and coolant applied to a workpiece. Removal of each and all of the particulate matter, gases, and coolant requires a relatively strong negative pressure or vacuum, which can negatively impact the operation of a torch, e.g., by interfering with or significantly influencing the proper formation and function of a plasma arc. Prior art systems are also plagued by having to manage large particulate matter and potentially free-flowing liquid coolant into the vacuum system, which can require costly vacuum systems for managing such materials in the vacuum line, and can result in damage to the vacuum system.

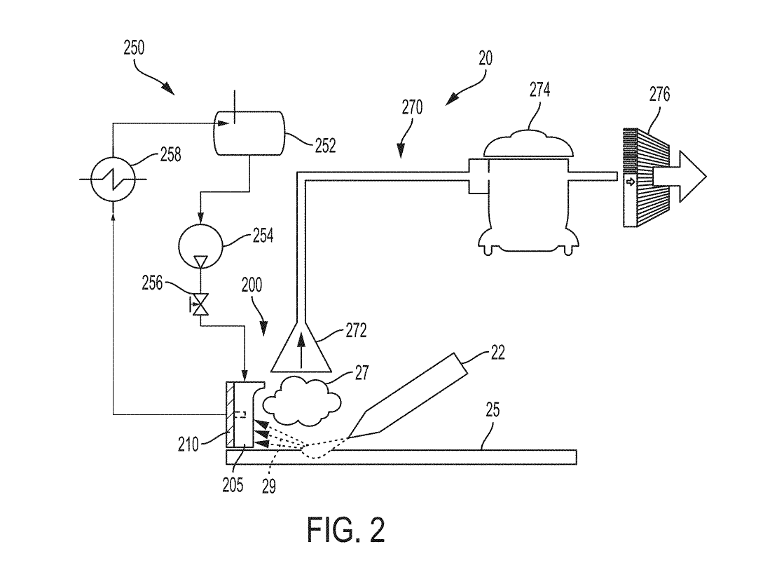

FIG. 2 is a block diagram of an embodiment of the invention, depicting a system for slag and fume management during material processing operations, e.g., during the operation of material processing system 20. Slag and fume management system 200 can be comprised of a variety of different elements for the management of gases and particulate matter expelled during a material processing operation, including, e.g., a plasma cutting or gouging operation. A material processing operation can include torch 22 and workpiece 25. In some embodiments, torch 22 can be, e.g., a plasma cutting torch or a carbon arc torch which can be used in, e.g., carbon arc gouging operations. Slag and fume management system 200 can be used in connection with a wide variety of cutting, welding, or gouging operations without departing from the spirit of the invention described herein.

Slag and fume management system 200 can include slag deflector 205. Slag deflector 205 can be disposed proximate to a material processing operation, e.g., at a distance sufficient to cool and redirect slag and/or particulate matter that is generated and dispelled during operation of material processing system 20. In some embodiments, slag deflector 205 can be disposed, e.g., between 0″ and 18″, between 0.5″ and 12″, between 0.25″ and 6″, between 0.5″ and 4″, between 0.75″ and 3″ from the contact point where the arc from torch 22 contacts workpiece 25. Slag deflector 205 can be made of a thermally-conductive material capable of dissipating heat of slag or particles and particulate that are dispelled from a material processing operation and impact slag deflector 205. In some embodiments, slag deflector 205 can be made of, e.g., copper. In some embodiments, slag deflector 205 can be formed from one or more materials, including, e.g., a base or body of slag deflector 205 and an impact surface that faces torch 22 during the material processing operation. In some embodiments, an impact surface can be integral with slag deflector 205. In some embodiments, slag deflector 205 can be made of a powder-coated material.

During a material processing operation, slag deflector 205 is placed at a distance from torch 22 of material processing system 20. In some embodiments, the surface of slag deflector 205, e.g., an impact surface, can be substantially perpendicular to the direction of travel of torch 20 during the material processing operation. In some embodiments slag deflector 205 can be placed at a bias or angle from the direction of travel of torch 20 during the material processing operation. The angle of slag deflector 205 can be chosen to redirect slag or particulate matter impacting the slag deflector in a desired direction or to a desired location at the discretion of an operator.

Slag and fume management system 200 can include coolant system 250. Coolant system 250 can be operatively coupled to slag deflector 205. In some embodiments, slag deflector 205 can include coolant component 210 that can facilitate connection of coolant system 250 to slag deflector 205. Coolant system 250 can include, e.g., air or liquid in order to dissipate heat and cool slag deflector 205, which is primarily heated as a result of impacting slag or particles from the material processing operation and secondarily from proximity to the arc. In some embodiments, coolant system 250 can be a closed-loop cooling system.

Coolant in coolant system 250 is stored in coolant reservoir 252. From coolant reservoir 252, coolant travels through, e.g., piping or flexible tubing, through fluid pump 254, by operation of fluid pump 254. In some embodiments, flow control valve 256 can be provided to meter flow of coolant through coolant system 250. Flow control valve 256 can be provided between fluid pump 254 and slag deflector 205, and can be, e.g., a needle valve, that is configured to adjust the coolant flow rate within coolant system 250. In some embodiments, there can be multiple flow control valves to control fluid flow through coolant system 250 in different parts of the system. In some embodiments, coolant system 250 can include a pump bypass valve and associated tubing that permits fluid pump 254 to operate while the material processing operation is at rest.

Coolant is pumped by fluid pump 254 to and/or into slag deflector 205. As shown in FIGS. 3B-1 through 3B-4, slag deflector 205 can include coolant flow channel 311. Coolant flow channels can be formed by, e.g., milled cooling channels that form a circuit on a rear surface of slag deflector 205 or by drilling or 3D printing internal passages into slag deflector 205 that are configured to allow coolant to pass and reduce the temperature of slag deflector 205. Coolant can be permitted to flow into coolant flow channel 311 by coolant flow inlet 306, which can be fluidly connected to the flexible tubing or piping of coolant system 250 and receive flow that has passed through, e.g., coolant reservoir 252, fluid pump 254, and/or flow control 256. Once coolant completes a circuit on the rear of slag deflector 205, it can flow through coolant flow outlet 308, which can be fluidly connected to the flexible tubing or piping of coolant system 250 and can expel flow that can travel toward, e.g., heat exchanger 258 or coolant reservoir 252. In some embodiments, heat exchanger 258 can be a chiller. The chiller can be configured to actively dissipate heat in coolant system 250 via, e.g., chilling or force cooling. In some embodiments, coolant flow channel 311 can be a plurality of coolant flow channels. In some embodiments, coolant flow channel 311 can form a serpentine or other pattern across the rear of slag deflector 205, e.g., to increase the rate of cooling of slag deflector 205. In some embodiments, fins or other features can be provided on the rear of slag deflector 205, which can be open to atmosphere, to permit for cooling of slag deflector 205.

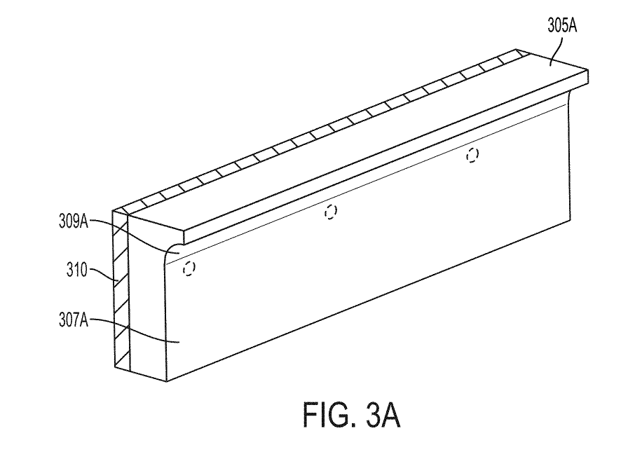

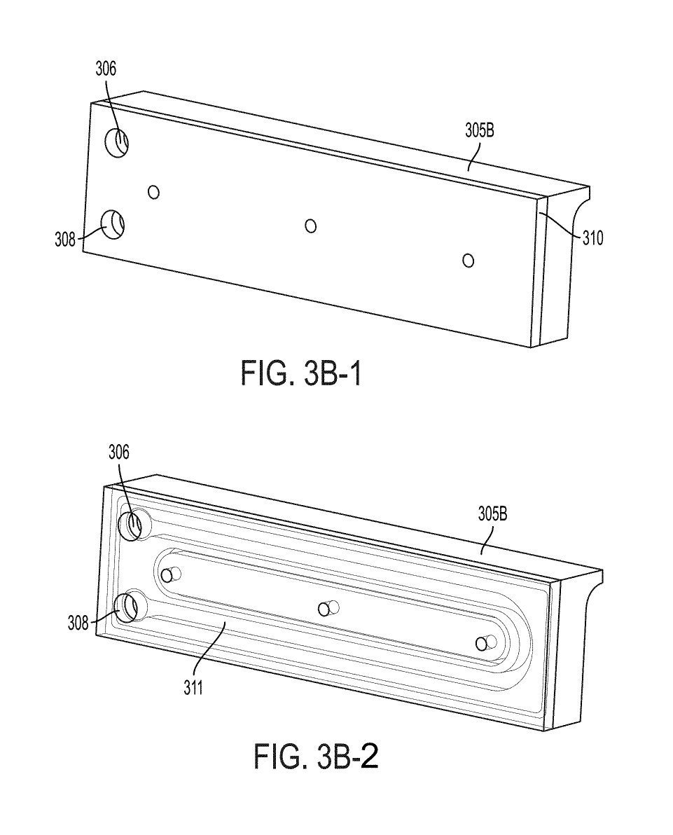

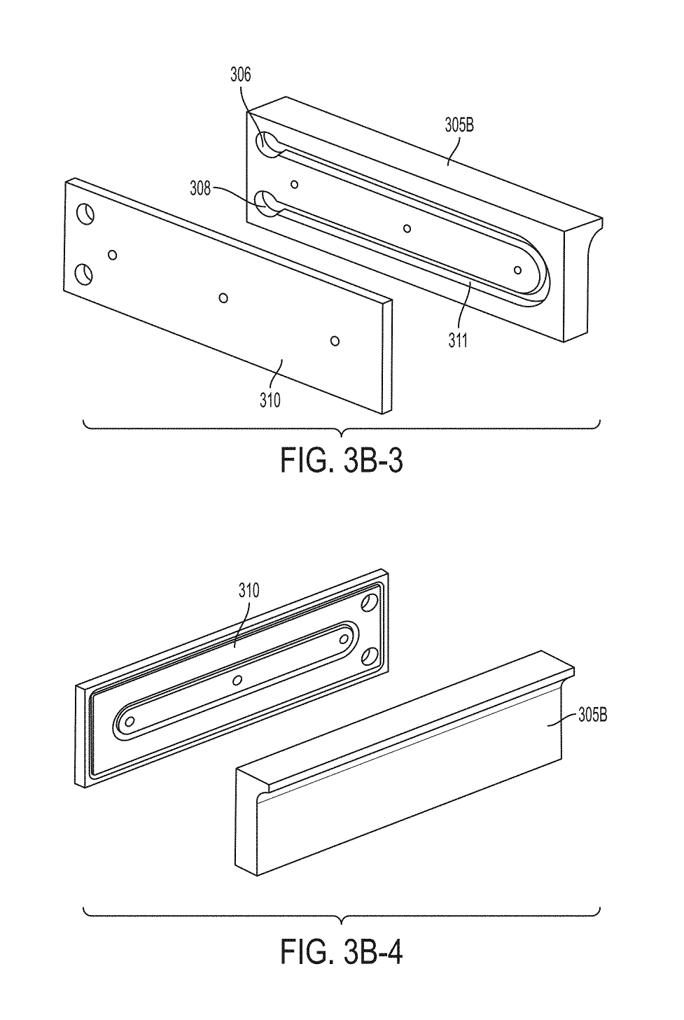

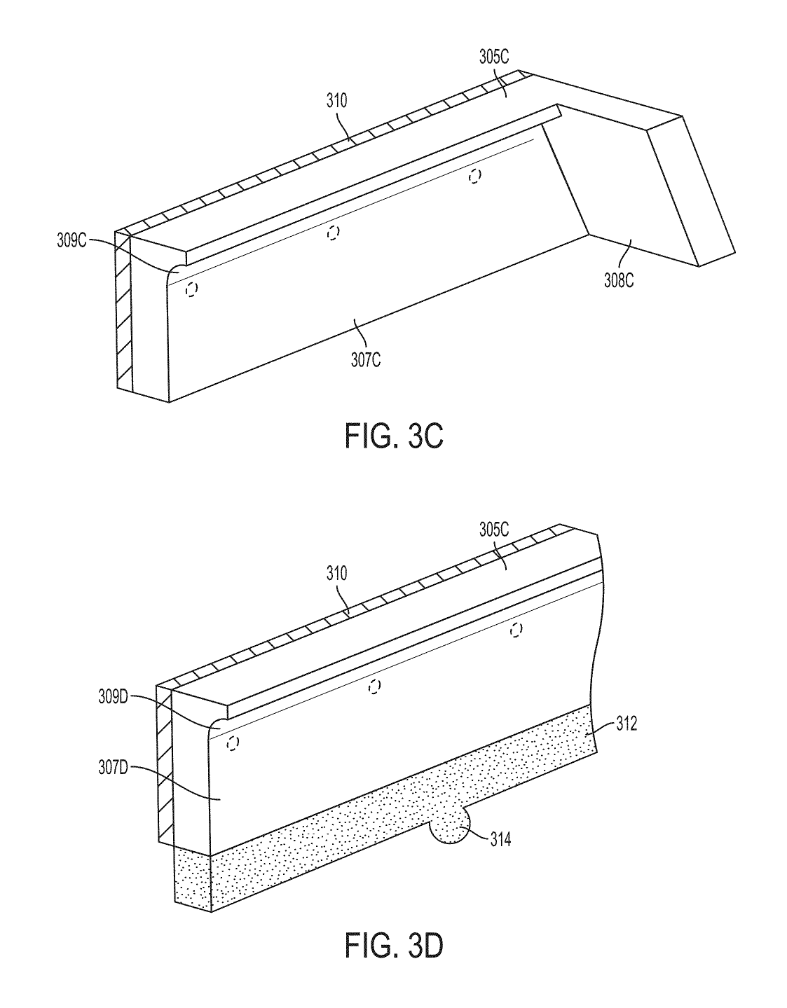

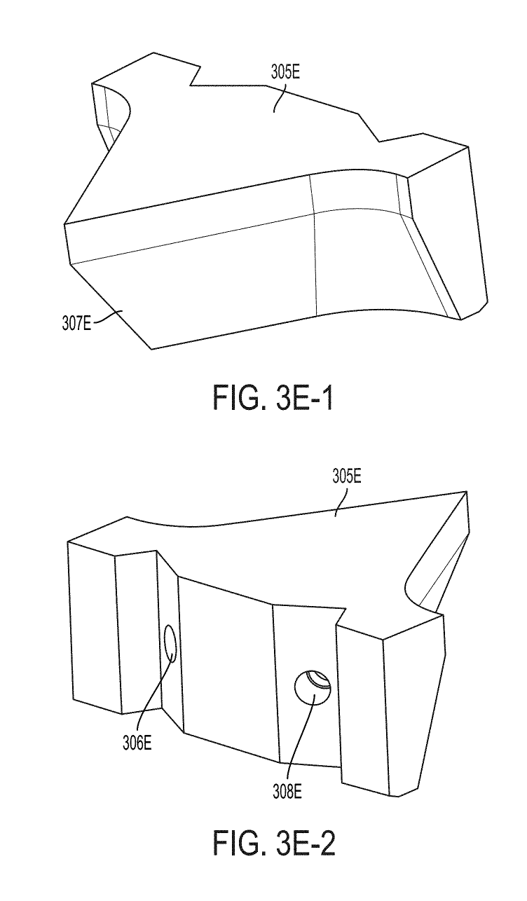

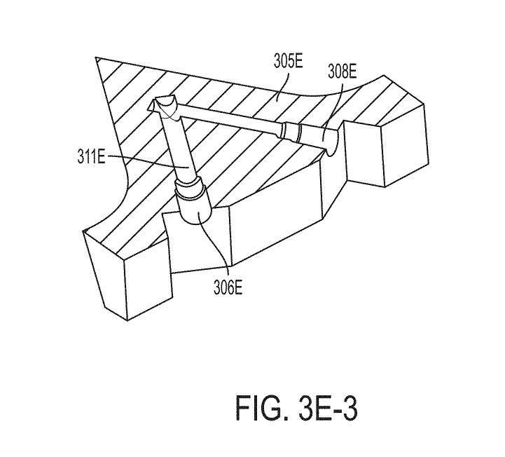

Coolant component 210 (corresponding to coolant component 310 in FIGS. 3A-3E) is a mating plate that encloses coolant flow channel 311 and forms a seal with the rear of slag deflector 205 through the use of, e.g., O-ring seals. In some embodiments, additional coolant flow channels or portions of fluid flow channels can be formed in coolant component 210. In some embodiments, coolant component 210 is unnecessary as coolant flow channel 311 is disposed completely within slag deflector 205. Coolant component 210 can be configured to interact with coolant flow inlet 306 and/or coolant flow outlet 308 and can mate with slag deflector 205 to permit fluid flow from coolant system 250 through coolant component 210 and into and through slag deflector 205.

Coolant exiting slag deflector 205 travels through, e.g., piping or flexible tubing to heat exchanger 258. In some embodiments, coolant exiting slag deflector 205 travels through, e.g., piping or flexible tubing to a chiller for cooling. Heat exchanger 258, or the chiller, cools coolant flowing through coolant system 250 to a lower temperature than when it exited slag deflector 205. In some embodiments, heat exchanger 258 returns coolant flowing through coolant system 250 to a temperature sufficiently low to cool slag deflector 205 when such coolant completes another cycle through coolant system 250. In some embodiments, heat exchanger 258 can be replaced by or used in conjunction with a chiller for lowering the temperature of coolant in coolant system 250.

Piping or flexible tubing used to connect the various components used in coolant system 250 can be rated to withstand high temperatures. In some embodiments, one type of flexible tubing or piping can be used to carry coolant flow from coolant reservoir 252 to slag deflector 205 and another type of flexible tubing or piping configured to withstand high temperatures can be used to carry coolant flow from slag deflector 205 to heat exchanger 258.

The various components of coolant system 250 can be controlled by closed-loop feedback control, e.g., via an independent microcontroller, a control system coupled to the other components of slag and fume removal system 200, or a control system coupled to material processing system 20 as a whole. The controller of coolant system 250 can be configured to operate various elements of the system under predefined or selected sets of conditions, e.g., to operate fluid pump 254 or heat exchanger 258 only when the temperature of coolant in coolant system 250 reaches a set temperature. In some embodiments, fluid can flow about coolant system 250 without operation of fluid pump 254, e.g., by the operation of convective or other thermal processes.

Material processing system 20 can also include a ventilation system 270. Ventilation system 270 can include suction manifold 272 that can be sized according to the particular material processing application, e.g., to maximize air velocity and integrate with the material processing operation. Fumes or gasses generated during the material processing operation are removed from the region proximate torch 22 by a negative pressure generated by vacuum head 274. Suction manifold 272 can be connected to vacuum head 274 by flexible tubing, which can be rated to withstand temperatures of heated gases and fumes passing through the tubing.

In some embodiments, vacuum head 274 can include an integral containment vessel for containing any small particles or slag (e.g., relative to the size of particles or slag that impact slag deflector 205) that enters ventilation system 270. In some embodiments, the strength of the negative pressure can be selected so as not to influence or impact the formation, shape, size, and/or operation of an arc created between torch 22 and workpiece 25. In some embodiments, the negative pressure generated by vacuum head 274 is selected to draw only fumes or gases into ventilation system 270. In some embodiments, such negative pressure is great enough that some portion of small particles generated by the material processing operation can be drawn into ventilation system 270 along with the fumes and gases. The containment vessel traps any such small particles before they are able to clog or damage ventilation system 270. Vacuum head 274 can be connected to filter 276, which filters out harmful portions of the fumes or gases drawn into ventilation system 270. Filter 276 can sufficiently filter harmful or dangerous elements from the fumes or gases such that gas expelled from filter 276 can be safely vented to atmosphere, e.g., such gasses expelled from filter 276 can meet applicable industry safety standards to be vented to atmosphere.

In some embodiments, coolant system 250 can be operatively connected to ventilation system 270 in addition to slag deflector 205. Coolant system 250 can exclude a heat exchanger element disposed on or near a tube or hose connecting suction manifold 272 to vacuum head 274 in order to cool down the temperature of fumes, gases, and/or small particulates that may be flowing through ventilation system 270. Integrating the functions of coolant system 250 and ventilation system 270 can have the impact of avoiding damage or wear to ventilation system 270 by cooling excessively hot gases and particulate matter that are sucked into ventilation system 270 by the negative pressure generated by vacuum head 274. In some embodiments, coolant system 250 can be fluidly connected to vacuum head 274 or a containment vessel included within ventilation system 270 to impart a similar cooling effect.

In some embodiments, suction manifold 272 and slag deflector 205 are mounted to a support structure. The support structure can be configured to move in, e.g., two dimensions, e.g., where workpiece 25 is substantially flat, or three dimensions, e.g., where workpiece 25 is curved or is an irregular shape. In some embodiments, suction manifold 272 and slag deflector 205 can be mounted to separate support structures.

In some embodiments, suction manifold 272 and slag deflector 205 can be mounted to the same support structure as torch 22, in such a manner that the distance between suction manifold 272 and slag deflector 205 remains constant as torch 22 moves relative to workpiece 25. Mounting each of the components to the same support structure can decrease the total amount of structural components in material processing system 20 and can eliminate the need for separate motion control. In some embodiments, the various support structure configurations can hold suction manifold 272, slag deflector 205, and/or torch 22 stationary in place while workpiece 25 is moved relative to torch 22 during the course of a material processing operation.

In some embodiments, positive air flow, an air blade, or a jet of compressed air can be used to manage, guide, and/or deflect slag or fumes generated during the material processing operation. The strength of the positive air flow can be selected so as not to interfere with formation of the plasma arc. The positive air flow can blow particulate matter toward the impact surface of the slag deflector, and/or can blow gas and/or particulates toward the suction manifold to be captured by the ventilation system. In some embodiments, positive airflow can create a flow that enshrouds a region proximate the torch in a pocket of air, in order to ensure that gases and particulates do not escape to atmosphere. In some embodiments, the positive air flow may be released or directed from the slag deflector, and can include recycled air from, e.g., ventilation system 270.

FIGS. 3A-E are different slag deflector embodiments for use with an exemplary system for slag and fume management during material processing operations. As described herein, slag and fume management system 200 can be implemented with a slag deflector having various sizes, shapes, and configurations, each of which can be advantageous for managing slag and fumes generated during a material processing operation. Each of exemplary slag deflectors 305A-D can be incorporated into exemplary slag and fume management system 200, substantially as described with respect to slag deflector 205. In some embodiments, each or any of exemplary slag deflectors 305A-D can be used on their own, e.g., without ventilation system 270 or without coolant system 250.

FIG. 3A depicts slag deflector 305A. Slag deflector 305A includes beveled surface 309A that blocks particulate matter impacting slag deflector 305A from traveling up and over slag deflector 305A and being vented to atmosphere. Slag deflector 305A can include impact surface 307A. During a material processing operation, e.g., during a plasma cutting or gouging operation, heated solid or molten slag or particulate matter can impact impact surface 307A and thus be prevented from traveling in a direction substantially parallel to a workpiece that is being cut. In some embodiments, impact surface 307A is integral to slag deflector 305A. In some embodiments, impact surface 307A can be made from a different material than the body of slag deflector 305A.

Slag deflector 305A can be attached to coolant component 310. In some embodiments, coolant component 310 can, e.g., enclose or include portions of a coolant flow channel, such as coolant flow channel 311. In some embodiments, coolant component 310 can be integrally formed with slag deflector 305A. In some embodiments, coolant component 310 can be a separate component attachable to slag deflector 305A and optionally can be made from a different material than slag deflector 305A.

The curvature of beveled surface 309A can be chosen to maximize the amount of solid or molten particulate matter redirected by slag deflector 305A. In some embodiments, the curvature of beveled surface 309A can increase or decrease along the length of slag deflector 305A. In some embodiments, the curvature of beveled surface 309A can begin at, e.g., ½ or ¼ or ⅛ or 1/12 of the height of slag deflector 305A. In some embodiments, slag deflector 305A can exclude beveled surface 309A. Slag deflector 305A can be disposed at an angle with respect to a workpiece being processed and/or a direction or torch travel across a workpiece. The angle between slag deflector 305A and a workpiece (e.g., workpiece 25) can be an acute angle in order to direct slag or particulate matter impacting slag deflector 305A in a downward direction toward the workpiece. In some embodiments, spaces or holes can be formed through slag deflector 305A, e.g., through beveled surface 309A. The spaces or holes can permit fumes or gases to vent in an upward direction through slag deflector, which fumes or gases can optionally be captured by ventilation system 270.

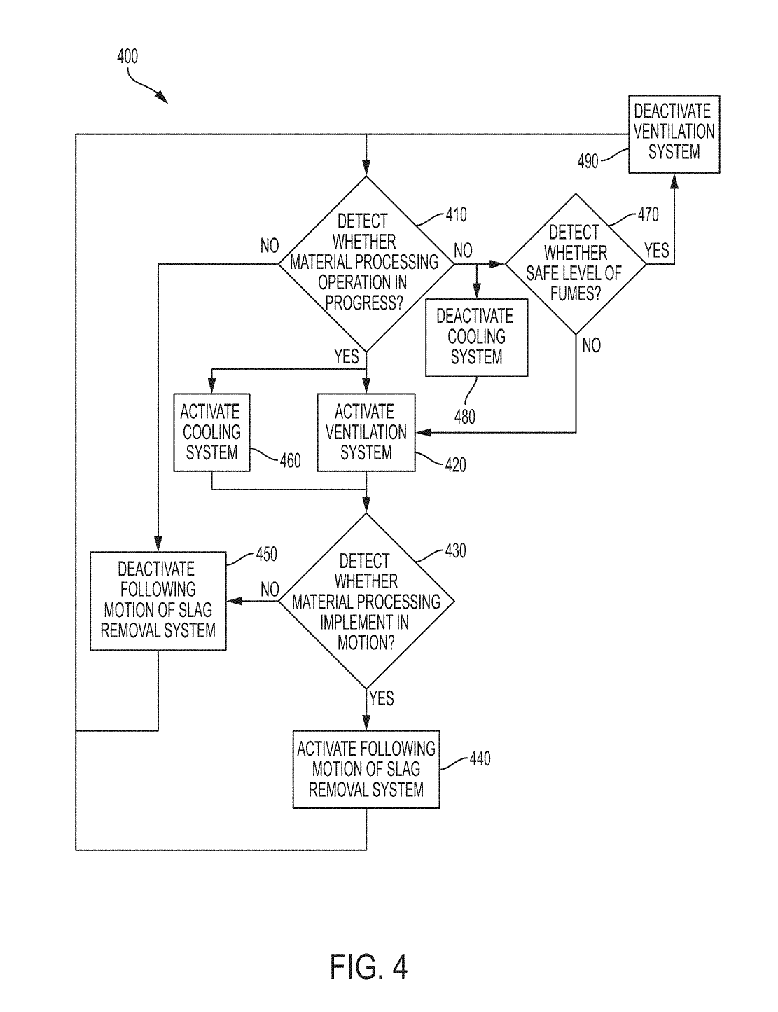

FIGS. 3B-1 through 3B-3 depict multiple rear views of exemplary slag deflector 305B and coolant component 310. FIG. 3B-1 depicts a transparency view wherein coolant component 310 is transparent in order to show coolant flow channel 311 formed in the rear of slag deflector 305B. As discussed above, coolant flow inlet 306 and coolant flow outlet 308 can operate to permit coolant to flow through coolant flow channel 308. In some embodiments, coolant component 310 can include fixtures, holes, or opening that can interact with coolant flow inlet 306 and coolant flow outlet 308 to connect to the remainder of coolant system 250. In some embodiments, coolant component 310 can include seals, e.g., o-ring seals, or rubber or a similar material seals, in order to assist in maintaining coolant within coolant flow channel 311 during operation of the slag and fume removal system, as shown in FIG. 3B-4.

FIG. 3C depicts slag deflector 305C. Slag deflector 305C can include each of the elements of slag deflector 305A. Slag deflector 305C includes secondary impact surface 308C, which is disposed at an angle to impact surface 307C of slag deflector 305C. In some embodiments, secondary impact surface 308C is disposed substantially perpendicularly to impact surface 307C of slag deflector 305C. In some embodiments, including the illustrated embodiment, secondary impact surface 308C is disposed at an acute or obtuse angle, e.g., 30 degrees, 45 degrees, 60 degrees, 90 degrees, 75 degrees, 120 degrees, 250 degrees, with respect to slag deflector 305C.

During a material processing operation, e.g., during operation of material processing system 20, slag deflector 305C can be employed to deflect slag or particulate matter generated during the material processing operation. Slag or particulate matter can impact impact surface 307C in a direction substantially perpendicularly to impact surface 307C, and can be deflected in a direction substantially parallel to impact surface 307C down the length of slag deflector 305C. Upon reaching secondary impact surface 308C, deflected slag or particulate matter can impact secondary impact surface 308C and be directed in a downward direction. In some embodiments, slag can be deflected by secondary impact surface 308C in a downward direction onto a workpiece, e.g., workpiece 25, at an area remote from the operation of the torch, e.g., torch 22, of the material processing operation. In some embodiments, slag can be deflected by secondary impact surface 308C in a downward or sideways direction off of the edge of a workpiece, e.g., onto the floor of a material processing operation or into a containment vessel configured to capture and retain waste slag and particulate matter.

FIG. 3D depicts slag deflector 305D. Slag deflector 305D includes sweep element 312 that is designed to sweep or slide over a workpiece being processed, in contact with the workpiece, in order to sweep or capture particulate matter left on the workpiece as slag deflector 305D moves with respect to the workpiece. In some embodiments, sweep element 312 is designed to prevent slag and/or particulates from sliding underneath slag deflector 305D after being expelled during a material processing operation. As the slag deflector translates across the workpiece (e.g., either as the slag deflector and/or torch are moved or as the workpiece is moved), it prevents waste material from building up on the surface of a workpiece, e.g., workpiece 25. In some embodiments, sweep element 312 can be formed from a sparse unwoven polymer or metal, e.g., a high-temperature cleaning pad or steel wool. In some embodiments, sweep element 312 can be a brush with sufficient bristles to remove particulate matter from the surface of the workpiece and prevent it from building up during a material processing operation.

In some embodiments, sweep element 312 includes ridge 314. While slag deflector 305D is translated across a workpiece during a material processing operation, ridge 314 can be configured to sweep through, e.g., a cut or gouge formed in a workpiece by a material processing implement, e.g., torch 22. In some embodiments, ridge 314 can be integrally formed with sweep element 312. In some embodiments, ridge 314 can be a separate element attached to sweep element 312 and/or can be formed from a different material from sweep element 312. In some embodiments, sweep element 312 does not include ridge 314.

Sweep element 312 (and/or ridge 314) can be removed and/or replaced without replacing the slag deflector. In some embodiments, as sweep element 312 wears out, e.g., from friction of sliding in contact with a workpiece or from the heat of impacting solid or molten particulate matter, it can be removed or replaced to ensure, e.g., that waste material is effectively removed from the surface of a workpiece or that sweep element 312 (and/or ridge 314) remain in contact with the workpiece (and/or a cut or groove therein) during a material processing operation. In some embodiments, sweep element 312 can include a magnet or an electromagnet that can be activated during operation to influence particulate motion and direction. In some embodiments, the electromagnet can be cycled for this purpose so as to not affix the slag deflector to the workpiece but to still influence the particulate. The power of the electromagnet can be selected such that it does not affix the impact surface to the workpiece but slows and/or influences slag and particulate motion across the workpiece, e.g., workpiece 25.

FIGS. 3E-1 through 3E-3 depict an exemplary slag deflector 305E. Slag deflector 305E can include impact surface 307E shaped in a reverse plow configuration as depicted. Slag and/or particulate matter from the material processing operation can impact slag deflector 305E and be redirected at an angle by impact surface 307E, e.g., a sideways and/or downward angle, on either side of slag deflector 305E. FIG. 3E-2 depicts the rear of slag deflector 305E. Slag deflector 350E can include coolant flow inlet 306E and coolant flow outlet 308E, which can connect to, e.g., coolant system 250, substantially as described above. In some embodiments, the front of slag deflector 305E (depicted in FIG. 3E-1) can face the torch of a material processing operation, e.g., torch 22. In some embodiments, impact surface 307E of slag deflector 305E can be disposed at an angle with respect to a workpiece, as depicted. In some embodiments, impact surface 307E of slag deflector 305E can be disposed perpendicularly to a workpiece. Slag deflector 305E can include a vertical element configured to prevent slag and particulate matter from venting vertically to atmosphere.

FIG. 3E-3 depicts a cutaway view of slag deflector 305E. Slag deflector 305E can include coolant flow channel 311E for cooling slag deflector 305E. Coolant flow channel 311E can take on a variety of shapes, including a serpentine shape, vertically and/or horizontally, within slag deflector 305E. In some embodiments, coolant flow channel 311E can be curved to permit easier flow of coolant through the channel.

In some embodiments, characteristics of each or any of exemplary slag deflectors 305A-E can be used in conjunction with characteristics described or depicted with respect to all or any other of slag deflectors 305A-E. For example, an exemplary slag deflector 305C that includes secondary impact surface 308C can also include a sweep element 312 as shown in FIG. 3D. The sweep element can extend along the entire bottom surface of slag deflector 305C, including the bottom surfaces corresponding to impact surface 307C and secondary impact surface 308C. In some embodiments, the sweep element can extend only along a bottom surface of slag deflector 305C corresponding to impact surface 307C. In some embodiments, openings or holes can be formed proximate a top surface of slag deflectors 305C, 305D, or 305E, substantially as described with respect to slag deflector 305A. Openings or holes can be formed in secondary impact surface 308C to permit fumes or gases to vent to atmosphere. Any of the slag deflectors 305A-E depicted in FIGS. 3A-3E can include a coolant flow channel.

FIG. 4 is an exemplary flow chart illustrating a method for slag and fume management during material processing operations. Slag and fume management method 400 can be performed by, e.g., the components of material processing system 20. Slag and fume management method 400 can be controlled with an integrated control system that can perform the steps of slag and fume management method 400. The integrated control system can be the same system used to control the operation of torch 22, or can be a separate control system dedicated to the operation of the components of slag and fume removal system 200 only. In some embodiments, the integrated control system can be a plurality of control systems, that together or separately can control, e.g., coolant system 250, ventilation system 270, the following motion of slag deflector 205, and/or torch 22. In some embodiments, the integrated control system can operate on the basis of on-demand control feedback, for example by operating only when a material processing operation is being performed.

In step 410, slag and fume removal method 400 determines or detects whether a material processing operation is in progress. That is, at step 410 the integrated control system can determine whether torch 22 is currently implementing a cutting or gouging operation on a workpiece. Where a cutting or gouging operation is being performed, slag and fume removal method can activate a ventilation system, e.g., ventilation system 270, in step 420 and can activate a cooling system, e.g., cooling system 250, in step 460. In some embodiments, for example where slag and fume removal system 200 does not include either a ventilation system 270 or a cooling system 250, the slag and fume removal method 400 can perform either one or none of steps 420 and/or 460.

Slag and fume removal method 400 next determines or detects whether the material processing implement, e.g., torch 22, is in motion across a workpiece in step 430. Where slag and fume removal method 400 detects that the material processing implement is in motion across a workpiece, the method activates the following motion of the slag and fume removal system, e.g., slag and fume removal system 100, in step 440. Step 440 permits the suction manifold, e.g., suction manifold 272, to remain in proximity with the material processing implement, e.g., torch 22, as it performs a cutting or gouging operation on the workpiece, e.g., workpiece 25, in order to maintain the correct distance for the suction manifold to draw fumes and gases, but not large, or any, particulate matter, into the ventilation system.

Step 440 also activates motion of the slag deflector, e.g., slag deflector 205, to correspond and follow the motion of the material processing implement, e.g., torch 22. The slag deflector follows the motion of the material processing implement in the same direction of the material processing implement, and can do so at a speed matching the speed of the material processing implement, in order to maintain a constant distance between the slag deflector and the material processing implement throughout the duration of the material processing operation.

In some embodiments, the slag deflector and/or suction manifold can be moved in a direction substantially parallel to the path of travel of the material processing implement. In some embodiments, e.g., where a workpiece is curved or irregularly shaped, the slag deflector and/or suction manifold can be moved in a direction biased at an angle from the motion of the material processing implement, in order to most effectively manage or retain slag and fumes generated during the cutting or gouging operation. In some embodiments, the slag deflector can be attached to the torch or to a gantry. In some embodiments, the slag deflector can be attached to the workpiece, e.g., via a magnet or electromagnet.

When it is determined in step 430 that the material processing implement is not in motion, slag and fume removal method 400 proceeds to step 450 where the following motion of the slag and fume removal system, e.g., slag and fume removal system 200, is deactivated. In some embodiments, the material processing operation can remain in progress even though the material processing implement is not in motion, e.g. where torch 22 continues to cut or gouge workpiece 25 but is not being moved relative to workpiece 25.

In some embodiments, the suction manifold and slag deflector can be incorporated to the same structural support assembly as the material processing implement, such that whenever the material processing implement is in motion, the suction manifold and slag deflector are also in motion. Where the components are disposed on the same structural support assembly in such a manner, the need for steps 430, 440, and 450 can be obviated.

From step 440, the slag and fume removal system returns to step 410, where it is detected whether the material processing operation is in progress. In that manner, slag and fume removal method 400 can form a closed-loop feedback control loop to continue operation up to and until a material processing operation is complete.

Where it is determined at step 410 that a material processing operation is not in progress, slag and fume removal system proceeds to step 450 where the following motion of the slag and fume removal system, including, e.g., the suction manifold and the slag deflector, is deactivated. Determining that the material processing operation is not in progress at step 410 also causes slag and fume removal method 400 to continue to step 480 where the cooling system is deactivated. In some embodiments, there can be a predetermined or preselected delay between slag and fume removal method 400 determining that the material processing operation has completed at step 410 and deactivating the cooling system at step 480. The cooling system, e.g., coolant system 250, can remain activated after the conclusion of the material processing operation in order to ensure that slag deflector, e.g., slag deflector 205, is returned to a safe temperature after having been impacted by molten or heated solid particulate matter during the course of operation.

In some embodiments, where slag and fume removal method 400 determines that the material processing operation is complete at step 410, the method can proceed to step 470 where it is detected whether the gases or fumes about the material processing operation, e.g., the gases and fumes proximate torch 22 or the gases that have proceeded through ventilation system 270 and are being expelled through filter 276 have reached safe levels. Step 470 can include measuring safety or toxicity characteristics of the gases in or being expelled from the ventilation system to determine whether the ventilation system has completely filtered toxic or unsafe characteristics of the fumes or gases before expelling to atmosphere. When it is determined that gases or fumes in the system have been appropriately managed, slag and fume removal method 400 can proceed to step 490 where the ventilation system is deactivated. The determination at step 470 whether to proceed to step 490 can be based on the described measurement or detection of safety or toxicity characteristics, or in some embodiments can be based on a predetermined or preselected time delay after detecting that the material processing operation is no longer in progress at step 410.

Where motion is referred to in the foregoing discussion of slag and fume removal method 400, it should be understood as relative motion between the torch and/or slag and fume removal system and the workpiece. That is, according to some embodiments of the invention, the material processing system, the slag and fume removal system, and/or the torch can be driven in motion while the workpiece is held stationary. In some embodiments, the material processing system, the slag and fume removal system, and/or the torch are held stationary while the workpiece is driven in motion relative to the stationary components. Driving in motion the workpiece instead of the other components can be used in some applications, e.g. where the workpiece is an irregular shape or when the material processing system, the slag and fume removal system, and/or the torch are particularly cumbersome. In some embodiments, the components of the system can undergo relative motion in two dimensions, e.g. where a workpiece is flat either in a horizontal or vertical configuration. In some embodiments, the components of the system can undergo relative motion in three dimensions, e.g. where a workpiece is irregularly shaped or curved, in order to effectively cut or gouge with the material processing implement and effectively manage slag and fumes with the method for slag and fume removal 400.

While various embodiments have been described herein, it should be understood that they have been presented and described by way of example only, and do not limit the claims presented herewith to any particular configurations or structural components. Thus, the breadth and scope of a preferred embodiment should not be limited by any of the above-described exemplary structures or embodiments, but should be defined only in accordance with the following claims and their equivalents.

What is claimed:

1. A system to prevent a flow of gas and particulates from spreading to atmosphere during a material processing operation, comprising:
a slag deflector disposed proximate a torch during the material processing operation, the slag deflector including:
a thermally-conductive base portion having an impact surface facing the torch, the impact surface shaped to
(i) prevent the flow of gas and particulates from the material processing operation from spreading in a direction away from a torch, wherein the flow of gas and particulates comprises a first flow of gas and a first flow of particulates; and
(ii) redirect the first flow of particulates to a surface configured to inhibit the first flow of particulates from flowing to atmosphere; and
a coolant flow channel operably coupled to the thermally-conductive base portion, the coolant flow channel configured to thermally regulate the impact surface of the thermally conductive base portion.

2. The system of claim 1 further comprising a suction device disposed proximate the slag deflector, wherein the suction device is configured to provide a negative pressure to draw the first flow of gas away from a workpiece and permit the first flow of particulate matter to impact the slag deflector without being drawn into the suction device.

3. The system of claim 1 further comprising a bottom member disposed proximate a bottom surface of the slag deflector and configured to maintain contact with a workpiece during the material processing operation.

4. The system of claim 3 wherein the bottom member further comprises a magnet for removably connecting the slag deflector to the workpiece.

5. The system of claim 1 wherein the coolant flow channel further comprises a closed-loop cooling system.

6. The system of claim 5 wherein the closed-loop cooling system further comprises a heat exchanger, a fluid pump, and a flow control valve.

7. The system of claim 5 wherein the closed-loop cooling system includes a chiller.

8. The system of claim 5 wherein the closed-loop cooling system further comprises a liquid.

9. The system of claim 2 further comprising a ventilation system operably coupled to the suction device, wherein the ventilation system includes a containment vessel configured to capture a second flow of particulates that enter the ventilation system.

10. The system of claim 1 further comprising a receptacle for retaining the first flow of particulates redirected by the slag deflector.

11. The system of claim 1 further comprising a vertical deflector disposed proximate a top surface of the thermally-conductive base portion, wherein the vertical deflector is shaped to separate the first flow of gases from the first flow of particulates.

12. The system of claim 1 further comprising an air jet configured to apply a positive air flow proximate the impact surface configured to direct the first flow of gases to the suction system.

13. The system of claim 1 further comprising an air jet configured to apply a positive air flow proximate the impact surface configured to direct the first flow of particulates along the impact surface.

14. A method for particulate and gas removal, comprising:
preventing a flow of particulate and gas from a material processing operation from spreading in a direction away from a torch, wherein the flow of particulate and gas comprises a first flow of particulate and a first flow of gas;
redirecting the first flow of particulate to a surface configured to inhibit the first flow of particulate from flowing to atmosphere with an impact surface of a slag deflector; and
thermally regulating the impact surface of the slag deflector with a coolant flow channel.

15. The method of claim 14 further comprising providing a negative pressure to draw the first flow of gas away from a workpiece and permit the first flow of particulate to impact the slag deflector without being drawn into a suction device disposed proximate the slag deflector.

16. The method of claim 14 further comprising stopping particulate expelled from the material processing operation from spreading off the surface of a workpiece with a flexible member disposed proximate a bottom surface of the slag deflector in contact with the workpiece.

17. The method of claim 16 further comprising removably attaching the slag deflector to the workpiece via a magnet.

18. The method of claim 14 further comprising providing coolant to the coolant flow channel through a closed-loop cooling system.

19. The method of claim 18 further comprising regulating the temperature of coolant in the closed-loop cooling system with a heat exchanger.

20. The method of claim 18 further comprising regulating the temperature of coolant in the closed-loop cooling system with a chiller.

21. The method of claim 15 further comprising filtering an input to the suction device and capturing a second flow of particulate that enters the suction device with a containment vessel, wherein individual particulates within the second flow of particulate are smaller than individual particulates within the first flow of particulate.

22. The method of claim 14 further comprising capturing the first flow of particulate redirected by the slag deflector with a receptacle.

23. The method of claim 14 further comprising separating the first flow of gas from the first flow of particulate with a vertical deflector disposed proximate a top surface of the thermally-conductive base portion.

24. The method of claim 14 further comprising enshrouding a region proximate the slag deflector with a positive air flow to prevent the first flow of particulate and the first flow of gas from escaping to atmosphere.
